(19) United States
(12) Patent Application Publication
(10) Pub. No.: US 2009/0108055 A1
(43) Pub. Date: Apr. 30, 2009

(54) PERSONALIZABLE CARDS SHARED VIA A COMPUTERIZED CARD SERVICE

(75) Inventors: Sandra Vargas, Sammamish, WA (US); Keith Rowe, Seattle, WA (US); Darren Apfel, Redmond, WA (US); Andrew Royal, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/924,625

(22) Filed: Oct. 26, 2007

(51) Int. Cl. G06F 19/00

(52) U.S. Cl. 235/375

(57) ABSTRACT

Systems and methods for sharing personalizable cards via a computerized card service are provided. One disclosed method includes, at a card client program executable on a computing device, creating a personalizable card having extensible data, and sending a first instance of the personalizable card to a card service program. The method may further include, at the card service program, propagating the first instance of the personalizable card to a peer of the user, and at the card client program, updating the extensible data of the personalizable card. Upon updating the extensible data, the method may further include sending a second instance of the personalizable card to the card service program, and propagating the second instance of the personalizable card to the peer of the user. The personalizable card may be propagated according to propagation permissions set by the user.

### BACKGROUND

Keeping track of information about friends is difficult. For example, there are many different locations in which data associated with different friends may be stored. Moreover, different locations may present different information about a single friend.

Accordingly, an individual may be required to spend a large quantity of time navigating to the different locations to gather information about a single friend or multiple friends. In many cases, in order to access the different locations, login identification and password information may be required. Thus, in order to access the different locations the login identification and password information for each location must be remembered or stored which may be perceived as a nuisance.

Furthermore, since the information about different friends may come from different sources that may utilize different data formats, it may be difficult to organize all of the data in a single format. Moreover, once the data is collected and organized the information about different friends may become out of date. Thus, in order to keep information about different friends updated an individual may be required to visit multiple locations with relative frequency to collect information about different friends and may have to use multiple applications to organize the collected data which may be very time consuming and frustrating for the user.

### SUMMARY

Systems and methods for sharing personalizable cards via a computerized card service are provided. One disclosed method includes, at a card client program executable on a computing device, creating a personalizable card, the personalizable card including extensible data corresponding to a user and being displayable on a computing device, and sending a first instance of the personalizable card to a card service program. The method may further include, at the card service program, propagating the first instance of the personalizable card to a peer of the user, and at the card client program, updating the extensible data of the personalizable card. Upon updating the extensible data, the method may further include sending a second instance of the personalizable card to the card service program, and propagating the second instance of the personalizable card to the peer of the user. The personalizable card may be propagated according to propagation permissions set by the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of one embodiment of a system for sharing personalizable cards via a computerized card service.

FIG. 2 shows a communication flow diagram demonstrating examples of selective propagation of various instances of a personalizable card based on propagation permissions.

FIGS. 3A-3C show schematic views of graphical user interfaces of the system of FIG. 1.

FIG. 4 is a flowchart of one embodiment of a method for updating a personalizable card and propagating the updated card to peers of a user.

FIG. 5 is a flowchart of one embodiment of a method for propagating a personalizable card to peers of the user based on propagation permissions.

### DETAILED DESCRIPTION

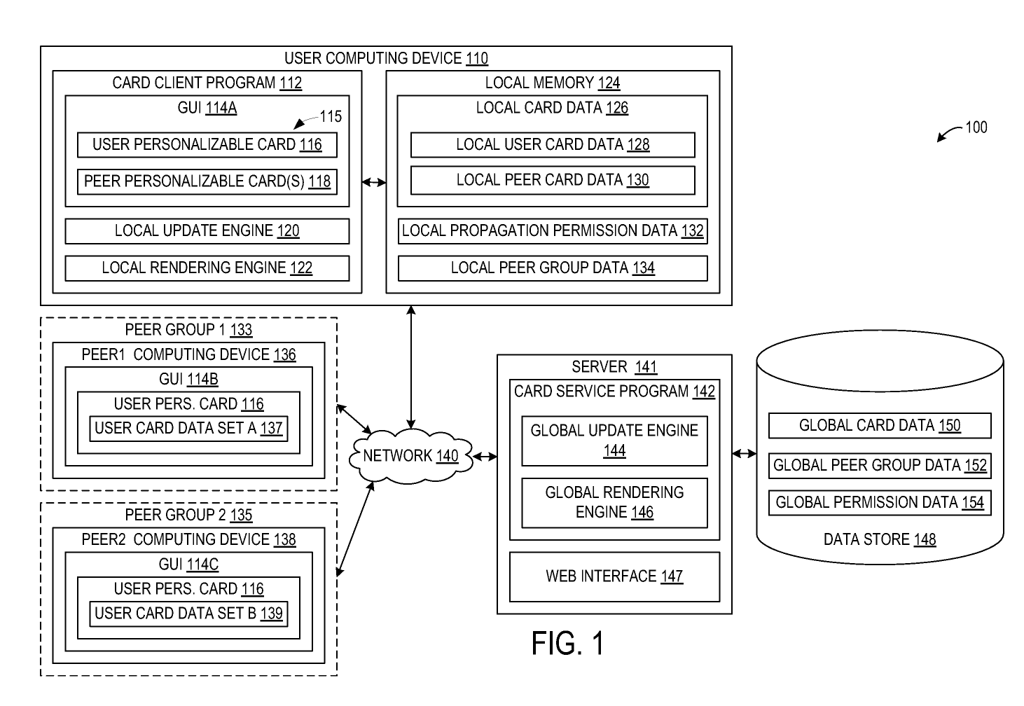

FIG. 1 illustrates a system 100 for creating and managing personalizable cards. System 100 may include a user computing device 110 configured to execute a card client program 112 via a processor of the computing device, using portions of local memory 124. Card client program 112 may be configured to facilitate creation and/or display of one or more personalizable card 115, including user personalizable cards 116 and peer personalizable cards 118. Personalizable cards 115 may include extensible data including various card elements, such as images, text, and other data, corresponding to and selected by a user, and may be displayable on a user computing device 110 via graphical user interface (GUI) 114A.

Upon creation of the user personalizable card 116 by the user, the extensible data of the user personalizable card 116 may be saved by card client program 112 in a non-volatile portion of local memory 124 of user computing device 110 in local user card data 128 of local card data 126. Thus, it will be appreciated that local user card data 128 may include data representing one or more card elements that are included in the user personalizable card 116. These card elements may include one or more of a text element, video element, audio element, graphical element, sound element, or metadata element, for example.

The format of the personalizable card 115 may follow a predetermined template, and also may be customizable by the user through the modification and addition of extensible data in personalizable cards 115. The extensible data is structured data that may be extended by inclusion by a user of one or more new structured data types in the user's personalizable card 115. Thus, it will be appreciated that a user may add a text element, video element, audio element, graphical element, sound element, or metadata element, as desired. In one example, the personalizable card 115 may include a theme or background data type and the user may personalize the personalizable card 115, for example, by modifying the theme or background to include a selected theme or background graphical element specified by the user. According to another example, the user may include a new structured data type in the card, such as a playable media element. Thus, the user may include audio or video data that is configured to play upon display of the card, for example. In this manner, the extensible data may be modified by the user to create a personalized card for the user.

Peer personalizable cards 118 of one or more peers of the user may be saved in local peer card data 130, and may be accessed, updated and displayed by card client program 112, as discussed below. Thus, it will be appreciated that local peer card data 130 may include data associated with peer personalized cards 118, such as data representing card elements of the data types discussed above for the peer personalizable cards.

In some embodiments, user personalizable card 116 may include data relating to peer personalizable cards 118 of one or more peers of the user. This data may take the form, for example, of links by which the peer personalizable cards 118 of the user may be accessed from the user personalizable card 116.

Upon creation of user personalizable card 116 by the user, card client program 112 may be configured to send the user personalizable card 116 to a card service program 142 executed on a server 141 via a network 140. Card service program 142 may store a copy of the user personalizable card 116 in a data store 148 as part of global card data 150. It will be appreciated that user personalizable card 116 may be one of a plurality of personalizable cards 115 stored in global card data 150. Each of the plurality of personalizable cards 115 stored in global card data 150 may correspond to a respective user of the system 100.

The card service program 142 may be configured to propagate user personalizable card 116 to one or more peers defined in the local peer group data 134 of the user, via network 140. Propagation of personalizable card 116 by card service program 142 may be based on propagation permissions, stored in local propagation permission data 132, which specify a set of data of the personalizable card that is to be sent to each peer. Local peer group data 134 includes data on individual peers and groups of peers of the user. For convenience, the propagation permissions may be applied to peers that are grouped in the peer groups defined in local peer group data 134. It should be appreciated that peer groups may include one or more peers. As an alternative, the propagation permissions may be applied to peers that are individually included in local peer group data 134.

By way of example, in the illustrated embodiment, the user is shown as having a first peer and a second peer. The user may assign the first peer to a first peer group 133 and may assign the second peer to a second peer group 135 via card client program 112 and the assignments maybe saved in local memory 124 in local peer group data 134, and transmitted by card client program 112 to card service program 142, and stored in global peer group data 152. Non-limiting examples of peer groups may include family, friends, coworkers, etc. As discussed above, it will be appreciated that a peer group may include a single peer, or a plurality of peers.

Further, the user may set propagation permissions for each of the respective peers, by defining peer groups via card client program 112. The propagation permissions may be saved in local memory 124 in local propagation permission data 132, and may be transmitted from the client card program 112 to the card service program 142 on server 141 and stored in global permission data 154.

Upon creation of user personalizable card 116 by the user, a copy of the user personalizable card 116 may be sent from the client card program 112 to the card service program 142, and stored in global card data 150. The card service program 142 is configured to reference global peer group data 152 and global permissions data 154, and to selectively propagate the user personalizable card 116 to one or more peers of the user based on propagation permissions and peer group data set by the user.

It will be appreciated that the user may set the propagation permissions on a peer group-by-peer group basis, and on a card element-by-card element basis, such that the user may specify in the propagation permissions which peer group is to receive propagations of which card elements in the user personalizable card 116. Card service program 142 may propagate the user personalizable card 116 to the peers of the user according to the propagation permissions, such that computing device 136 of the first peer may receive a first instance of personalizable card 116, which may be displayable on GUI 114B, and computing device 138 of the second peer may receive a second instance of personalizable card 116, which may be displayable on GUI 114C.

Since the user may define propagation permissions for peer groups on a card element-by-card element basis, the two instances of the personalizable card sent to the two peers may include separate data sets. For example, the instance of the personalizable card sent to the first peer may include user card data set A, shown at 137, and the instance of the personalizable card sent to the second peer may include user card data set B, shown at 139. In the depicted embodiment, the propagation permissions for the first and second peers differ, and thus user card data set A differs from user card data set B. However, it will be appreciated that the first and second peers would receive the same set of data for user personalizable card 116 if the same propagations permissions were set for each of the first and second peers.

The card service program 142 may be further configured to enable the each of the peers to opt out of receiving the user personalizable card 116 of the user, or updates or modifications thereto. In this manner, unwanted distribution of user personalizable cards may be avoided.

It will be appreciated that personalizable card 116 may be extensible. That is to say, rather than having a static data structure, the personalizable card may include a dynamic number of card elements that may be modified by the user. In particular, the user may update the extensible data of the personalizable card by adding elements to the personalizable card, removing existing elements from the personalizable card, and/or modifying existing elements of the personalizable card via card client program 112.

Updates, for example, by adding, removing, and modifying card elements in the extensible data of personalizable card 116, may be performed by the user both directly and indirectly. For example, updating the extensible data of the personalizable card may include modifying the extensible data directly via user input from the user.

As another example, updating the extensible data of the personalizable card may include receiving a data stream from an external source based on a subscription established by the user, and converting the data stream into the extensible data by rendering the data stream into a standardized schema of the global system format. Data streams from external sources such as a third party may be received by card client program 112 or card service program 142, and may be integrated in to the personalizable card via local rendering engine 122 in card client program 112 or global rendering engine 146 in card service program 142. In one example, local rendering engine 122 may be configured to receive data to be stored in the personalizable card and convert the data to be stored in the personalizable card from a native format to a global system format that may be recognized by the various card clients of system 100. The local rendering engine 122 may render a data stream by embedding the native format of the external data stream into an extensible markup language (XML) format which may include additional layers of XML metadata appended to the data stream. Further, it may be appreciated in one example that a personalizable card may be implemented as an XML file and extensible data to be added to the personalizable card via local rendering engine 122 which may modify a data streams into a format representable in the XML file.

In response to a modification of extensible data of personalizable card 116, local update engine 120 may send the updated instance of the personalizable card to card service program 142. Card service program 142 may be configured to receive updated instances of personalizable cards from a plurality of card client programs. Each of the updated instances of personalizable cards may correspond to a user. The updated instances of personalizable cards may include modified extensible data, such as a modified card element. Upon receiving each updated instance of the personalizable cards, card service program 142 may be configured to store the updated instances of personalizable cards in data store 148. In some embodiments, storing the updated instances may include replacing a pervious instance of the personalizable cards. It will be appreciated that modification of extensible data associated with a personalizable card may include modification of extensible card data, propagation permission data, and/or peer group data. In some embodiments, global rendering engine 146 may be configured to parse the modified extensible data of a personalizable card according to data type and may store the modified parsed data types in global card data 150, global group data 152, and/or global permission data 154.

Further, card service program 142 may be configured to identify a peer group of the user, and based on propagation permissions associated with the peer group may selectively send the updated instance of the personalizable card to the peers in the peer group, via global update engine 144. The propagation permissions may expressly permit or prohibit the propagation of card data. For example, the propagation permissions may permit some or all of the modified extensible data within the personalizable card to be sent to one or more peers, e.g., on a card element-by-card element basis. As another example, the propagation permission may prohibit some or all of the extensible data of the personalizable card to be sent to one or more peers, such that the extensible data of the personalizable card that is not authorized by the propagation permissions to be sent to the peers is not sent to those peers.

In addition to propagating a personalizable card in response to modification of extensible data of the personalizable card, the local update engine 120 of the card client program 112 may be configured to send a request to card service program 142 upon execution of card client program 112 to receive any updated personalizable cards of peers of the user. Card service program 142 may be configured to selectively send a stored updated instance of the personalizable card of each peer of the user to card client program 112 in response to receiving a request for the most recent instance of the personalizable card from the user.

In addition to updating peer personalizable cards already stored on user computing device 110, the user may designate a new peer and request a personalizable card from the newly designated peer. In response, local update engine 120 may send a request for the peer personalizable card 118 of the peer to card service program 142. Upon receiving the request, card service program 142 may send the stored updated instance of the personalizable card of the peer to the user based on the propagation permissions. In turn, card client program 112 may receive the personalizable card 118 of the peer. The personalizable card 118 of the peer may include extensible data including card elements corresponding to the peer, and may be displayable on a user computing device 110 via graphical user interface (GUI) 114A. Local update engine 120 may store the extensible data of the newly obtained peer personalizable card 118 in local memory in local peer card data 130.

The above described system 100 gives a user control over the user personalizable card 116, such that the personalizable card 116 may be created and propagated to peers, updated in a manner that is propagated to peers, and ultimately removed from the local data stores of peers, at the direction and control of the user.

While the above interactions of the system 100 are discussed with reference to a server 141 communicating with a card client program 112 on a user computing device 110, it will be appreciated that the client program 112 may be a browser client on the user computing device 110, and the functionality described above may be implemented by accessing a web interface 147 provided on the server 141 using the browser client. The user may login to the web interface 147 using the browser client, and access user-specific data from data store 148, using a user account maintained on the server 141.

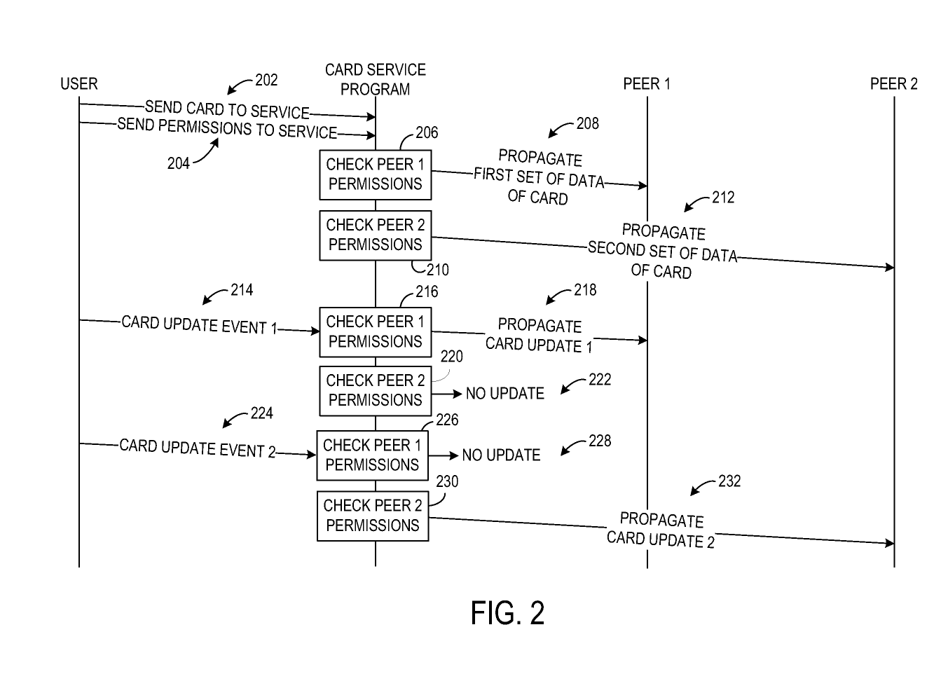

FIG. 2 illustrates a communication flow diagram demonstrating examples of selective propagation of various instances of personalizable card 115 based on propagation permissions. At 202, a user may send a personalizable card to the card service program, for example upon creation of the personalizable card. The personalizable card sent to the card service program may include a set of all extensible data of the personalizable card. At 204, the user may send propagation permissions to the card service program, including permissions for a first peer and permissions for a second peer of the user. At 206 and 210, the card service program may check the propagation permissions for the first and second peers in order to identify which peers of the user may receive the personalizable card and which set of data may be included in the personalizable card sent to each peer.

At 208, the card service program has determined that the propagation permissions permit a first instance of the personalizable card including a first set of data to be sent to a first peer of the user, and thus sends the first instance of the personalizable card including the first set of data to the first peer.

At 210, the card service program determines that the propagation permissions permit a second instance of the personalizable card including a second set of data to be sent to a second peer of the user. At 212, the card service program sends the second instance of the personalizable card including the second set of data to the second peer.

The user may update extensible data of the personalizable card and as a result, as depicted at 214, the updated instance of the personalizable card may be sent to the card service program as a first card update event.

At 216, the card service program determines that the propagation permissions permit an updated instance of the personalizable card to be sent to the first peer of the user. At 218, the card service program sends the updated instance of the personalizable card to the first peer. It will be appreciated that the updated instance of the personalizable card sent to the first peer may include a portion or all of the extensible data updated during the first update event based on the propagation permissions.

At 220, the card service program determines that the propagation permissions do not permit an updated instance of the personalizable card to be sent to the second peer of the user, and thus as illustrated at 222 no update is sent to the second peer. The updated instance of the personalizable card may not be sent to the second peer based on a determination that the updated extensible data, such as a card element, of the personalizable card is not permitted to be propagated to the second peer of the user. Alternatively, the propagation permissions for the second peer may have changed, prohibiting the updated instance from being sent to the second peer.

At 224, the user may again update extensible data of the personalizable card and thus the updated instance of the personalizable card may be sent to the card service program as a second card update event.

At 226, the card service program determines that the propagation permissions do not permit an updated instance of the personalizable card to be sent to the first peer of the user, and thus as illustrated at 228, no update is sent to the first peer. As above, the updated instance of the personalizable card may not be sent to the first peer based on a determination that the updated extensible data of the personalizable card is not permitted to be propagated to the first peer of the user. Alternatively, the propagation permissions for the first peer may have changed, prohibiting the updated instance from being sent to the first peer.

At 230, the card service program determines that the propagation permissions permit the updated instance of the personalizable card to be sent to the second peer of the user. At 232, the card service program sends the updated instance of the personalizable card to the second peer of the user. It will be appreciated that the updated instance of the personalizable card propagated to the second peer may include a portion or all of the extensible data updated during the second update event based on the propagation permissions.

In above described manner, the user may utilize propagation permissions to cause updates to the user personalizable card 116 to be selectively propagated to peers.

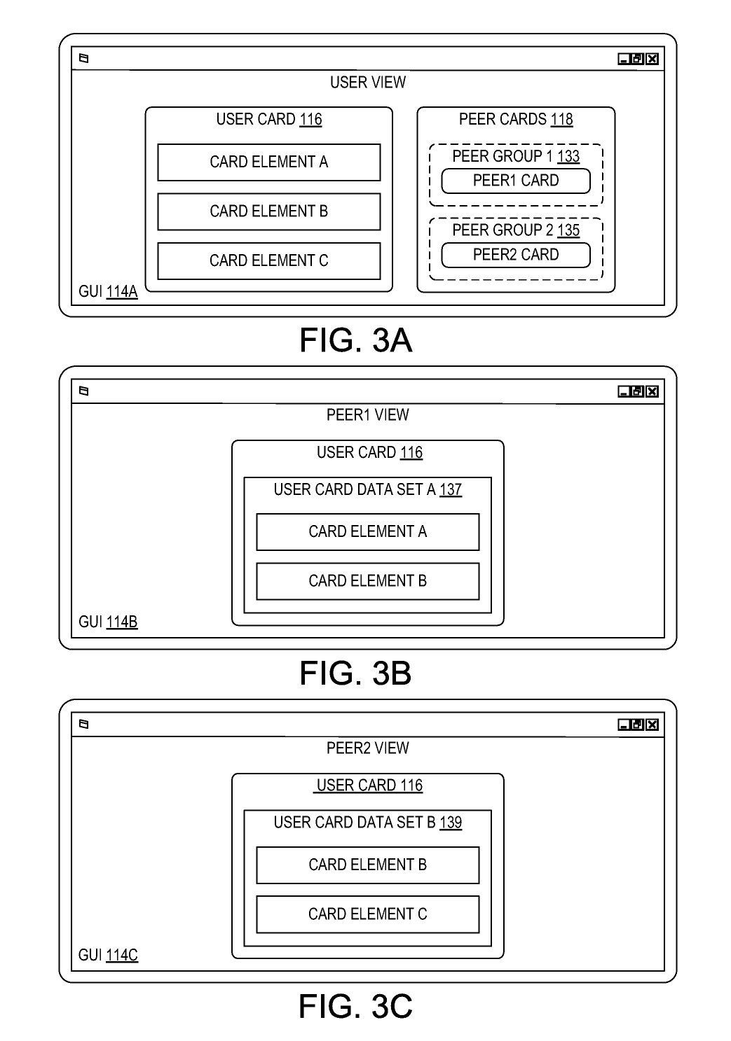

FIGS. 3A-3C show different example views of the GUIs (114A, 114B, 114C of FIG. 1) that may be configured to display the user personalizable card 116 of the user and/or the peer personalizable card(s) 118 of peers of the user. Each of FIGS. 3A-3C may correspond to a different view of user personalizable card 116 as seen from the view of the user (FIG. 3A), a first peer of the user (FIG. 3B), and a second peer of the user (FIG. 3C). The extensible data displayed in each view of the personalizable card of the user may be determined by the propagation permissions associated with the personalizable card.

FIG. 3A shows GUI 114A as viewed by the user. Personalizable card 116 of the user as displayed shows all current card elements included in the personalizable card 116, i.e., card element A, card element B, and card element C. Further, GUI 114A may present personalizable cards 118 of peers of the user. Peer cards 118 may be organized into various peer groups, if desired. For example, a first peer group 133 may include the personalizable card of a first peer of the user and a second peer group 135 may include the personalizable card of a second peer of the user. The instances of peer personalizable cards displayed on GUI 114A include card elements that have been propagated by the card server program 142 based on corresponding propagation permissions defined by the peer owners of each card.

FIG. 3B shows GUI 114B as viewed by the first peer of the user. Based on the propagation permissions assigned to first peer group 133 to which the first peer belongs, personalizable card 116 may be sent to the first peer with user card data set A indicated at 137, which in the depicted embodiment includes card element A and card element B. It will be appreciated that the propagation permissions for the first peer group may limit the extensible data of the user personalizable card 116 that is sent to the first peer group. In particular in this example, the propagation permissions for the first peer group do not permit card element C to be included in the instance of the personalizable card of the user sent to the first peer group.

FIG. 3C shows GUI 114C as viewed by the second peer of the user. Based on the propagation permissions assigned to second peer group 135 to which the second peer belongs, personalizable card 116 may be sent to the second peer with user card data set B indicated at 139, which in the depicted embodiment includes card element B and card element C. It will be appreciated that the propagation permission of the second peer group may limit the extensible data of the user personalizable card 116 that is sent to the second peer group. In particular in this example, the propagation permissions for the second peer group do not permit card element A to be included in the instance of the personalizable card of the user sent to the second peer group.

It will be appreciated that in some cases, more than one peer group may have the same propagation permissions and therefore may receive the same instance of the personalizable card. Further, while propagation permissions have been in some contexts described herein as being defined according to peer groups as a matter of convenience, it will be appreciated that setting propagation permissions for a group effectively sets the permissions for each of the peers within the group. Further, it will be appreciated that system 100 may be configured to enable a user to set propagation permissions for individual peers on a peer-by-peer basis.

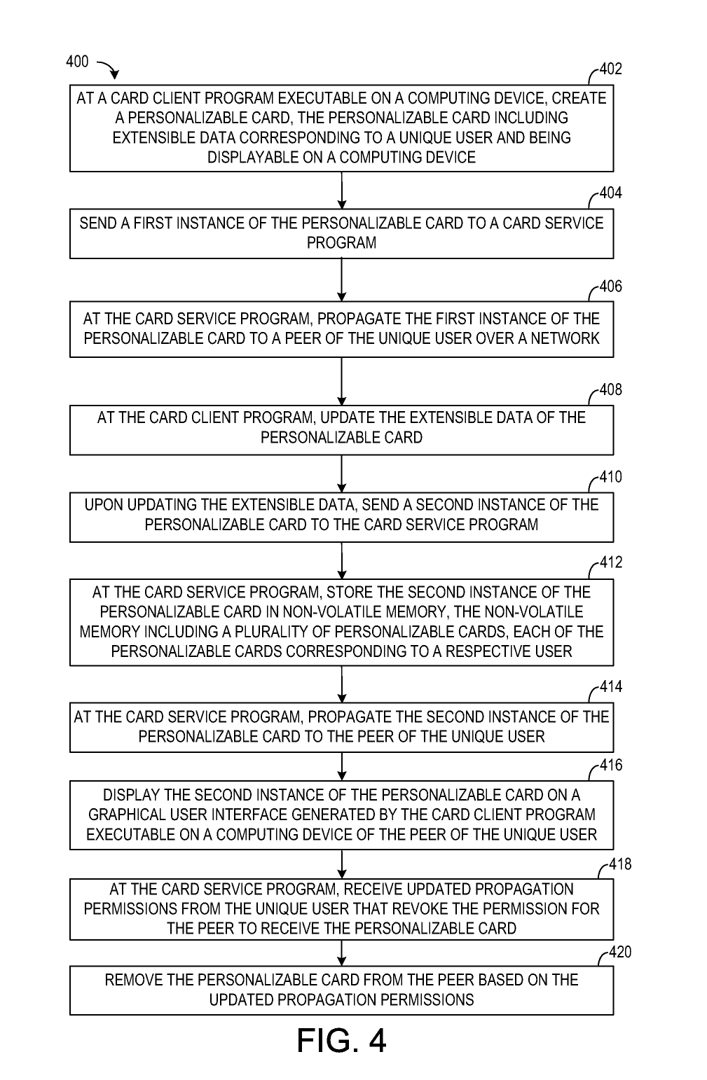

FIG. 4 illustrates one embodiment of a method 400 for distributing a personalizable card to peers of a user. At 402, the method typically includes at a card client program, creating a personalizable card. The personalizable card is typically created in response to a user request received from a user, and may include extensible data corresponding to a user. For example, extensible data may include different card elements, such as a text element, video element, audio element, graphical element, sound element, and metadata element. Further, the personalizable card may be displayable on a computing device.

At 404, the method may include sending a first instance of the personalizable card to a card service program. The personalizable card may be sent with associated propagation permissions for the card, which define card elements of the personalizable card that are authorized to be sent to peers of the user. At 406, the method may include at the card service program, propagating the first instance of the personalizable card to one or more peers of the user over a network. The card may be propagated based on the propagation permissions, so that peers receive the card elements of the personalized card that they are authorized to receive by the propagation permissions, as discussed above. At 408, the method may include, at the card client device, updating the extensible data of the personalizable card. For example, updating the extensible data may include adding, removing, and/or modifying a card element of the personalizable card. Along with the update to the extensible data of the card, or independent thereof, the method may also include receiving from the user updated propagation permissions and/or updated peer groups, and sending the updated propagation permissions and/or peer groups to the card service program.

At 410, the method may include upon updating the extensible data, sending a second instance of the personalizable card to the card service program, including the updated extensible data. In addition, if the propagation permissions and/or peer groups have been modified, this second instance of the personalized card may be sent according to updated propagation permissions and/or peer groups.

At 412, the method may include, at the card service program, storing the second instance of the personalizable card in non-volatile memory of a data store associated with the card service program. The non-volatile memory of the data store may include a plurality of personalizable cards and each of the personalizable cards may correspond to a respective user.

At 414, the method may include, at the card service program, propagating the second instance of the personalizable card to one or more peers of the user. The second instance of the personalizable card may be selectively propagated based on the propagation permissions and the peer groups defined by the user and associated with the personalizable card.

At 416, the method may include displaying the second instance of the personalizable card on a graphical user interface generated by the card client program. The card client program may be executable on a computing device of each of the one or more peers of the user.

At 418, the method may include, at the card service program, receiving updated propagation permissions from the user that revoke the permission for the peer to receive the user personalizable card. At 420, the method may further include removing the personalizable card from the peer based on the updated propagation permissions.

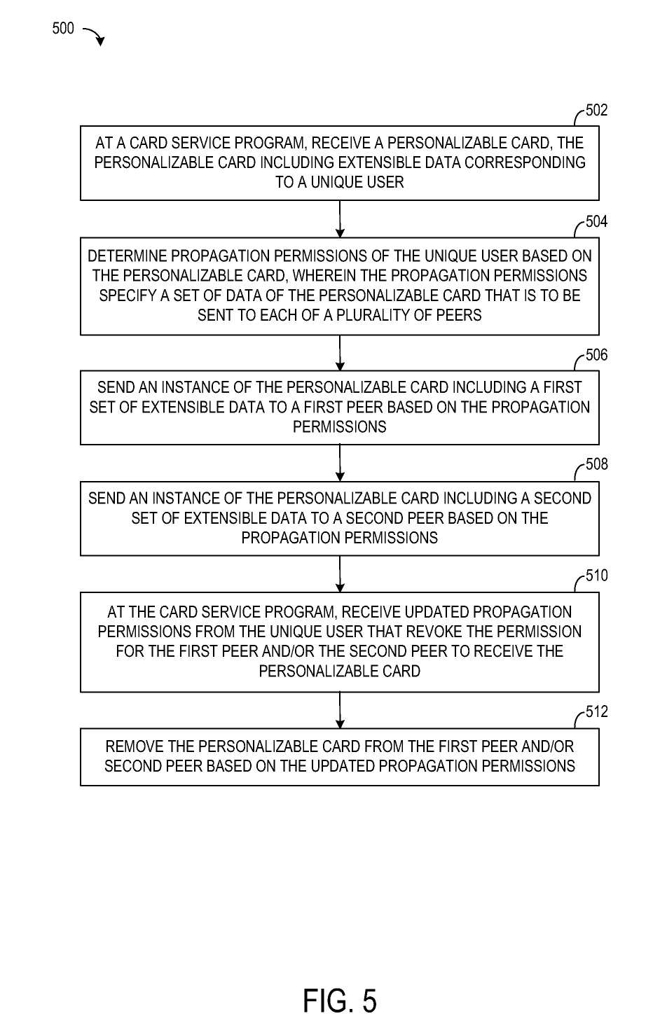

FIG. 5 illustrates another embodiment of a method 500 for distributing a personalizable card to peers of a user. At 502, the method may include at a card service program, receiving a personalizable card including extensible data that corresponds to a user. The extensible data may include one or more card elements of various data types, as described above. At 504, the method may include determining propagation permissions of the user that are associated with the personalizable card. The propagation permissions may specify a set of data of the personalizable card that is to be sent to one or more peers of the user, for example, on a peer by peer basis, and on a card element-by-card element basis. The propagation permissions may be defined to apply to peers within a peer group, if desired.

At 506, the method may include sending an instance of the personalizable card that includes a first set of extensible data to a first peer based on the propagation permissions. At 508, the method may include sending and instance of the personalizable card that includes a second set of extensible data to a second at least one of a peer and a peer group based on the propagation permissions.

At 510, the method may include at the card service program, receiving updated propagation permissions from the user that revoke the permission for at least one of the first peer or peer group and the second peer or peer group to receive the personalizable card. At 512, the method may include removing the personalizable card from the at least one of the first peer or peer group and the second peer or peer group based on the updated propagation permissions.

The above described methods enable a user to effectively control the distribution of a personalizable card to peers. By setting different propagation permissions for different peers or peer groups, a user may selectively propagate different information from the personalizable card of the user to different peers or peer groups, and may modify or remove, partially or entirely, the propagated personalizable cards from the computing devices or accounts of peers to which the personalizable cards were sent. Furthermore, the personal data of different users may be selectively propagated to peers of the user in response to the users updating the data in a personalizable card, without any specific request from the peers to for the personal data. In this manner, a user may conveniently share data with peers via the personalizable cards described herein in a manner that may be propagated, updated, and revoked at the user's discretion.

It will be appreciated that the computing devices described herein may be any suitable computing device configured to execute the programs and display the graphical user interfaces described herein. For example, the computing devices may be a personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for managing extensible data on a personalizable card, the method comprising:
at a card client program executable on a computing device, creating a personalizable card, the personalizable card including extensible data corresponding to a user and being displayable on a computing device;
sending a first instance of the personalizable card to a card service program;
at the card service program, propagating the first instance of the personalizable card to a peer of the user over a network;
at the card client program, updating the extensible data of the personalizable card; and
upon updating the extensible data, sending a second instance of the personalizable card including updated extensible data to the card service program; and
at the card service program, propagating the second instance of the personalizable card to the peer of the user.

2. The method of claim 1, wherein the second instance of the personalizable card is selectively propagated to the peer of the user based on propagation permissions set by the user.

3. The method of claim 2, wherein the extensible data includes a plurality of card elements, and the propagation permissions are set for each card element.

4. The method of claim 3, wherein the plurality of card elements are selected from a group consisting of a text element, video element, audio element, graphical element, sound element, and metadata element.

5. The method of claim 1, wherein updating the extensible data of the personalizable card includes modifying the extensible data via user input from the user.

6. The method of claim 1, wherein updating the extensible data includes adding and/or removing a card element of the personalizable card.

7. The method of claim 1, wherein updating the extensible data includes:
receiving a data stream from an external source based on a subscription established by the user; and
converting the data stream into the extensible data by rendering the data stream into a standardized schema of the personalizable card.

8. The method of claim 1, further comprising:
at the card service program, storing the second instance of the personalizable card in memory, the memory including a plurality of personalizable cards, each of the personalizable cards corresponding to a respective user.

9. The method of claim 1, further comprising:
displaying the second instance of the personalizable card on a graphical user interface generated by a card client program executable on a computing device of the peer of the user.

10. The method of claim 1, further comprising:
at the card service program, receiving updated propagation permissions from the user that revoke the permission for the peer to receive the user personalizable card.

11. The method of claim 10, further comprising:
removing the personalizable card from the peer based on the updated propagation permissions.

12. A method of selectively propagating personalizable card data, the method comprising:
at a card service program, receiving a personalizable card, the personalizable card including extensible data corresponding to a user;
determining propagation permissions of the user based on the personalizable card, wherein the propagation permissions specify a respective set of data of the personalizable card that is to be sent to each of a plurality of peers of the user;
sending an instance of the personalizable card including a first set of the extensible data to a first peer based on the propagation permissions; and
sending an instance of the personalizable card including a second set of the extensible data to a second peer based on the propagation permissions.

13. The method of claim 12, wherein extensible data of the personalizable card that is not authorized by the propagation permissions to be sent to a peer is not sent to that peer.

14. The method of claim 12, wherein the extensible data includes a plurality of card elements, and the propagation permissions are set for each card element.

15. The method of claim 12, further comprising:
at the card service program, receiving updated propagation permissions from the user that revoke the permission for the first peer and the second peer to receive the personalizable card; and
removing the personalizable card from the first peer and the second peer based on the updated propagation permissions.

16. The method of claim 14, wherein the card service program is configured to enable the each peer to opt out of receiving the personalizable card of the user.

17. A personalizable card system, comprising:
a card service program configured to receive updated instances of personalizable cards from a plurality of card client programs, each of the updated instances of personalizable cards corresponding to a user, the updated instances of personalizable cards including modified extensible data, wherein upon receiving each updated instance of the personalizable card, the card service program is further configured to identify a peer of the user, and based on propagation permissions associated with the peer, to selectively send the updated instance of the personalizable card to the peer.

18. The system of claim 17, wherein the propagation permissions permit a set of the modified extensible data within the personalizable card to be sent to the peer.

19. The system of claim 17, wherein the card service program is further configured to store the received updated instance of the personalizable cards in memory accessible by the card service program.

20. The system of claim 19 wherein the card service program is further configured to selectively send a stored updated instance of the personalizable card of a user to a card client program in response to receiving a request for the most recent instance of the personalizable card from a peer of the user, the card service program sending the stored updated instance of the personalizable card based on the propagation permissions.
